(19) United States
(12) Patent Application Publication
(10) Pub. No.: US 2014/0246219 A1
(43) Pub. Date: Sep. 4, 2014

(54) CATEGORY 8 CABLE

(71) Applicant: James F. Rivernider, Ware, MA (US)

(72) Inventor: James F. Rivernider, Ware, MA (US)

(21) Appl. No.: 14/194,791

(22) Filed: Mar. 2, 2014

Related U.S. Application Data
(60) Provisional application No. 61/771,667, filed on Mar. 1, 2013.

(51) Int. Cl. H01B 11/08

(52) U.S. Cl. CPC H01B 11/08
USPC 174/103; 174/107

(57) ABSTRACT

This cable is meant for high speed Ethernet applications. For 40 Gbit/sec data rates, the frequency range of the cable is expected to be at least 2 GHz. All cable performance parameters are expected to be extended to at least 2 Ghz. This includes near end crosstalk. The challenge for cable manufacturers is to produce a cable that avoids “spikes” in NEXT and FEXT to 2 Ghz. The proposed design requires only 1 or 2 pair desirable pair combinations because the shield isolates the pairs into 2 groups of 2 pair. The method of applying the shield eliminates 4 (or possibly 5) required pair combinations by needing only pair 1 to pair 2 and pair 3 to pair 4. It is possible the combination of pair 1 to pair 2 could be used in both groups. The method of applying the shield also reduces the need to increase the insulation thickness to achieve the desired impedance because the shield is not as tight to the pairs.

This cable is meant for high speed Ethernet applications. For 40 Gbit/sec data rates, the frequency range of the cable is expected to be at least 2 GHz. All cable performance parameters are expected to be extended to at least 2 Ghz. This includes near end crosstalk. The challenge for cable manufacturers is to produce a cable that avoids “spikes” in NEXT and FEXT to 2 Ghz. Crosstalk is the result of coupling between the wire pairs. It is believed that repetitions (natural or the result of manufacturing defects) in the cable lays cause coupling to add constructively, resulting in “spikes” in near end crosstalk at certain frequencies. In a current four pair UTP or F/UTP cable, 6 combinations (pair 1 to pair 2, pair 1 to pair 3, pair 1 to pair 4, pair 2 to pair 3, pair 2 to pair 3 and pair 3 to pair 4) must be found that have repetitions or defects outside the desired frequency range. This is spacing greater than ½ wavelength of the max frequency of interest. This is difficult when the frequency range is more than 500 Mhz wide because the shorter wavelengths make more challenging to find lay combinations that do not repeat in that frequency range. One solution is to shield all 4 pair to eliminate coupling. The drawback of this solution is the size of the cable and pair. In order to produce a shielded pair with a specified impedance the insulation thickness must be increased significantly over a UTP cable with the same impedance. This increases the cost size and stiffness of the cable. Another solution is to increase the size or thickness of a separator or filler used to increase the distance between the pairs. This would increase the size of the cable and increases the stiffness of the cable. A third option is to intentionally vary the pair lays during manufacturing. This complicates the manufacturing operation. The proposed design requires only 1 or 2 pair desirable pair combinations because the shield isolates the pairs into 2 groups of 2 pair. The method of applying the shield eliminates 4 (or possibly 5) required pair combinations by needing only pair 1 to pair 2 and pair 3 to pair 4. It is possible the combination of pair 1 to pair 2 could be used in both groups. The method of applying the shield also reduces the need to increase the insulation thickness to achieve the desired impedance because the shield is not as tight to the pairs.

### BRIEF DESCRIPTION OF THE DRAWINGS

FIG. 1 is a cross-section of a first arrangement of the shield on the wire.

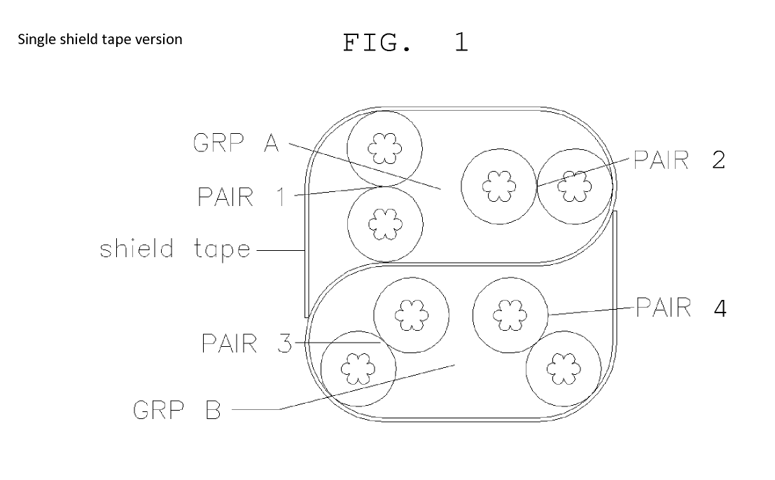

FIG. 2 is a cross-section of a second arrangement of the shield on the wire.

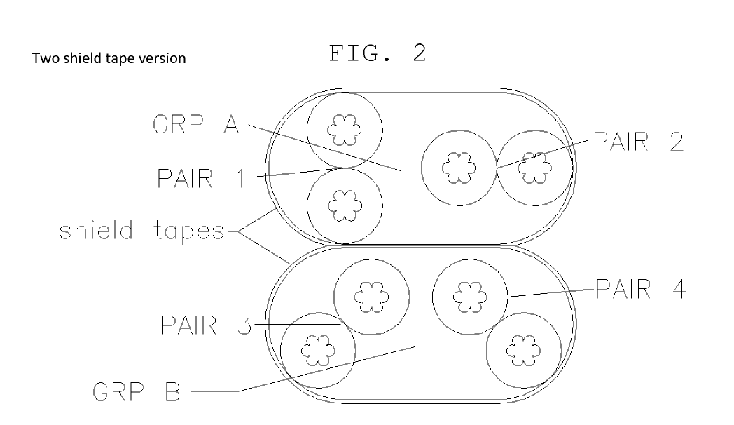

### DESCRIPTION OF THE INVENTION

Cable is made of 2 groups of two pair. Wire is insulated with polymer (example is HDPE) solid or foamed. The core would be wrapped with a least one shield tape in an “S” arrangement. That is the shield wraps around the each group and passes between them. A second shield tape could be applied over the entire core. A jacket of standard wire and cable material such as PVC would be applied of the core. Another possible way to make the cable is to apply a foil around 2 pair at a time so that there are 2 groups of 2 pair each with a shield. This would result in 2 layers of foil between the groups of 2 pair. In each group one pair is a longer lay and one pair is a shorter lay.

Since the coupling between the two groups of pairs is minimized by the shield it is possible that the lays in group A are identical to group B. The lays in group A and group B can be different provided 2 combinations without constructive addition can be found. Interactions between group A and group B are not a concern due to the shield or shields.

In a third configuration, a shield is placed around group A, and another shield is placed around both group A and group B.

In a fourth configuration, a shield is placed around group A, and another shield is in the jacket that surrounds both group A and group B.

1. A cable meant for high speed Ethernet applications For 40 Gbit/sec data rates, so that the frequency range of the cable is expected to be at least 2 Ghz, comprising:
a. a core, comprising:
a-i. a first group of two pairs of insulated wire,
b-ii. a second group of two pairs of insulated wire,
c-iii. A radiation shield that radiationally isolates the first pair, from second pair, and
d-iii. A radiation shield that radiationally isolates the first pair, from second pair,
b. an outer jacket surrounding the core.

2. A cable meant for high speed Ethernet applications For 40 Gbit/sec data rates, so that the frequency range of the cable is expected to be at least 2 Ghz, comprising:
a. a core, comprising:
a-i. a first group of two pairs of insulated wire,
b-ii. a second group of two pairs of insulated wire,
c-iii. A radiation shield that surrounds the first pair, but not the second pair, and
d-iii. A radiation shield that surrounds the second pair, but not the first pair,
b. an outer jacket surrounding the core.

3. A cable meant for high speed Ethernet applications For 40 Gbit/sec data rates, so that the frequency range of the cable is expected to be at least 2 Ghz, comprising:
a. a core, comprising:
a-i. a first group of two pairs of insulated wire,
b-ii. a second group of two pairs of insulated wire, and
c-iii. A radiation shield that surrounds the first pair, but not the second pair,
b. an outer jacket surrounding the core.
